(19) United States
(12) Patent Application Publication
(10) Pub. No.: US 2010/0094478 A1
(43) Pub. Date: Apr. 15, 2010

(54) POWER SUPPLY AND METHODS THEREOF

(76) Inventors: GARY FAILS, Tappan, NY (US); Lauren Dunn, New York, NY (US); Paul Kleissler, Englewood, NJ (US)

Correspondence Address: MALDJIAN & FALLON LLC, 365 BROAD STREET, THIRD FLOOR, RED BANK, NJ, 07701, US

(21) Appl. No.: 12/618,712

(22) Filed: Nov. 14, 2009

Related U.S. Application Data
(63) Continuation-in-part of application No. 11/109,012, filed on Apr. 18, 2005.

(51) Int. Cl. G06F 1/26

(52) U.S. Cl. 700/297

(57) ABSTRACT

Embodiments of the present invention generally relate to a power supply apparatus and method of utilizing the same. In one embodiment of the present invention, a power supply comprises a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output, and a converter configured to receive the data formatted in the industry-standard communication protocol and convert the data to a protocol compatible with a load.

### CROSS-REFERENCE TO RELATED APPLICATIONS

This application is a continuation-in-part of U.S. patent application Ser. No. 11/109,012, filed Apr. 18, 2005, which claims the benefit of U.S. Provisional Patent Application Ser. No. 60/582,695, filed Jun. 24, 2004, the disclosures of which are incorporated herein by reference in their entireties.

### BACKGROUND

1. Field of the Disclosure

Embodiments of the present disclosure generally relate to a power supply apparatus and method of utilizing the same. More specifically, embodiments of the present disclosure relate to a power supply apparatus and methods for selectively controlling entertainment and architectural fixtures utilizing the same.

2. Description of Related Art

Entertainment and architectural lighting and effects systems are often elaborate and include a vast array of fixtures that produce numerous effects. Traditionally, the set up of these systems has been a manually intensive and time-consuming process involving the manual configuration of settings on each fixture. In order to reduce the time and complexity of setting up these systems, computerized power supply systems have been designed.

Generally, in current power and data supply systems, an initial manual configuration or assignment of a communication protocol address is required in order to operate a fixture with an industry-standard controller. Effectively, the serial number of the fixture is assigned a standard address (e.g., a DMX address) utilizing a hand-held device, and the address is associated with that fixture until a user goes through a labor intensive process of manually configuring or re-assigning a new address to the fixture(s) in a system.

Other current designs utilize a fixed slot size per output port, and all output ports are configured the same. Thus, these current designs can only support fixtures of the same slot count. Since each port has the same slot footprint, and there is only one DMX address for the base unit, each port is then assigned an address as the base address plus slot size of the previous port, effectively locking the fixture address and drastically reducing any flexibility.

Thus, there is a need for a power supply apparatus for providing power and data to a plurality of loads, capable of configuring each port to have a unique address and slot size, thus providing unique control of every load in communication therewith.

### SUMMARY

Embodiments of the present invention generally relate to a power supply apparatus and method of utilizing the same. In one embodiment of the present invention, a power supply comprises a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output, and a converter configured to receive the data formatted in the industry-standard communication protocol and convert the data to a protocol compatible with a load.

In another embodiment of the present invention, a power supply system comprises a controller for transmitting control data to a power supply, the control data formatted in an industry-standard communication protocol, a plurality of loads, and a power supply comprising a plurality of outputs, each output configured for an assignable start address and a variable number of slots, an input for receiving control data from the controller, a logic unit configured to assign the start address and the number of slots for each output, the logic unit further configured to selectively distribute received control data to each output, a power unit configured to provide power through each output, and a converter configured to receive the control data formatted in the industry-standard communication protocol and convert the control data to a protocol compatible with at least one of the plurality of loads.

In yet another embodiment of the present invention, a method for operating a plurality of controllable loads comprises providing a power supply, the power supply comprising a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output, and a converter configured to receive the data formatted in the industry-standard communication protocol and convert the data to a protocol compatible with a load; providing a plurality of loads; establishing a first number of slots for a first output of the plurality of outputs, and associating a number of loads therewith; establishing a second number of slots for a second output of the plurality of outputs, and associating a number of loads therewith; assigning a first start address with the first output; and assigning a second start address with the second output.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a schematic diagram of a power supply in accordance with one embodiment of the present invention;

FIG. 2 depicts a schematic diagram of a power supply system in accordance with one embodiment of the present invention;

FIG. 3 depicts a flowchart illustrating a method of processing input data within a power supply in accordance with one embodiment of the present invention; and

FIG. 4 depicts a flowchart illustrating a method of operating a power supply in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the Figures.

### DETAILED DESCRIPTION

Embodiments of the present disclosure generally relate to a power supply apparatus and method of utilizing the same. More specifically, embodiments of the present disclosure relate to a power supply apparatus and methods for selectively controlling entertainment and architectural fixtures utilizing the same.

As used herein, the term “load,” and derivative forms thereof, may refer to any entertainment and/or architectural fixture, including entertainment and/or architectural lighting and effect devices, for example, stationary and moving luminaries, dimmers, stepper motors, fog/ smoke generators, and the like.

As used herein, the term “industry-standard communication protocol,” and derivative forms thereof, may refer to any conventional communication protocol, including, for example, DMX512, Remote Device Management (RDM), Advanced Control Network (ACN), ArtNet, American National Standards Institute (ANSI), W-DMX, Bluetooth, WiMax, Wi-Fi, Ultra Wideband (UWB), Wireless Application Protocol (WAP), Universal Mobile Telecommunications System (UMTS), Evolution-Data Optimized (EV-DO), High Speed Packet Access (HSPA), Code Division Multiple Access 2000 (CDMA2000), General Packet Radio Service (GPRS), Global System for Mobile Communications (GSM), Enhanced Data Rates for GSM Evolution (EDGE), Wibree, ZigBee, Z-Wave, Wireless Universal Serial Bus (WUSB), EnOcean, ONE-NET, Long Term Evolution (LTE), Lumen, and any other communication protocol, whether currently in existence, or not yet developed.

Various embodiments of the present disclosure are described below. It should be appreciated, however, that the present invention is not limited to any particular manner of implementation, and that the various embodiments discussed explicitly herein are primarily for purposes of illustration. For example, the various concepts discussed herein may be suitably implemented in a variety of environments involving light emitting diode (LED) based light sources, other types of light sources, environments that involve both LED and other types of lights sources in combination, and environments that involve non-lighting-related devices alone or in combination with various types of light sources.

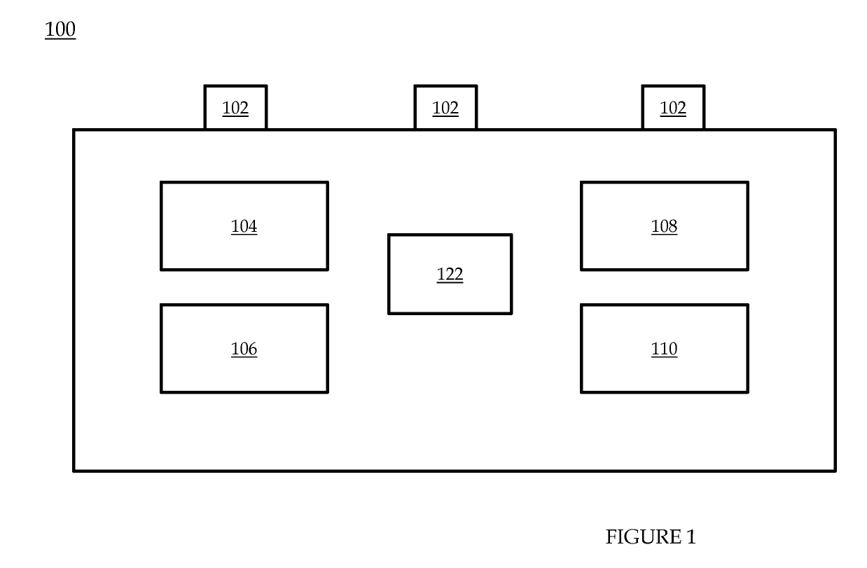

FIG. 1 depicts a schematic diagram of a power supply in accordance with one embodiment of the present invention. In one embodiment, in a basic form, the power supply 100 comprises at least a plurality of selectable outputs 102, an input 104, a logic unit 106, a power unit 108, and an optional converter 110. In addition, the power supply 100 may further comprise an optional user interface 122 for receiving input commands from a user (not shown).

In accordance with one embodiment of the present disclosure, the plurality of selectable outputs 102 may comprise any number of outputs suitable for embodiments of the present invention. Each output 102 of the plurality of outputs may generally be coupled to at least one load, and in many instances, a plurality of loads.

In many embodiments, each output 102 comprises a connector for transmitting signals from the power supply 100 to at least one load (not shown). The connector may comprise any type of connector suitable for embodiments of the present invention. In many embodiments, the connector may comprise any industry-standard connector, including for example, at least one of a XLR connector (e.g., a 3, 4, 6 or 7 pin XLR connector), Registered Jack (RJ) connector, optical fiber connectors (such as an LC, SC or MTP connector), Universal Serial Bus (USB) connectors, screw terminals, D-subminiature connectors, or the like.

In certain embodiments, each output 102 may be required to transmit data and power to a load. In such embodiments, each output 102 must comprise a communications interface for relaying commands and data to and/or from a load, and a power interface for powering the load. In one embodiment, a communication interface may comprise hardware for transmitting and receiving data and commands, for example, hardware adapted for communication using any of the industry-standard communication protocols. In another embodiment, the power interface may comprise hardware for providing requisite power to keep a load in an operating mode, for example, hardware adapted for power or electric signal protocols, such as EIA-485 protocols, or the like.

Each output 102 may further comprise a variable number of slots, or slot size, such that a variable number of loads may be in communication with each output 102. For example, in one embodiment, a first output may be set to comprise 5 slots for loads, and a second output may be set to comprise 3 slots for loads. Using the same embodiment, in another example, the first output may be adjusted to comprise 3 slots for loads, and the second output may be adjusted to comprise 5 slots for loads. It should be appreciated by embodiments of the present invention, designating a particular number of slots per output may be done without physical reconfiguration of the power supply 100, rather the physical connection to the loads is independent of the output which is in communication with any particular load.

In one embodiment of the present invention, the input 104 may comprise a hardware configuration suitable to receive data and or commands from the user interface 122. In many embodiments, the input 104 may comprise any type of connector suitable for embodiments of the present invention. In some embodiments, the connector may comprise any industry-standard connector, including for example, at least one of a XLR connector (e.g., a 3, 4, 6 or 7 pin XLR connector), Registered Jack (RJ) connector, optical fiber connectors (such as an LC, SC or MTP connector), Universal Serial Bus (USB) connectors, screw terminals, D-subminiature connectors, or the like.

The logic unit 106 may comprise any number of components required to perform the necessary functions of the logic unit 106 as described herein. Generally, the logic unit may be configured to process incoming data and/or commands from the input 104, selectively distribute received data or commands to each output 102, may also assign the start address and the number of slots for each output 102.

In order to selectively distribute received data or commands to each output 102, the logic unit 106 may comprise components for identifying an address within received data, selecting the proper output 102 for which the received data is intended, and transmitting the data through the appropriate output 102. Similarly, in order to assign a start address and number of slots for each output 102, the logic unit 106 may comprise components for instructing any number of physically connected loads to receive data or commands for a particular output. In addition, the logic unit 106 may comprise components to selectively identify any individual load, and assign it an address (e.g., a DMX address), to allow for unique control over each load.

The converter 110 may comprise any components suitable to receive data formatted in an industry-standard communication protocol and convert the data to a protocol compatible with a load. Such protocol conversion allows for the use of the power supply 100 where the incoming data and/or commands are provided using an industry-standard communication protocol, and where the loads require proprietary or manufacturer-specific communication protocols.

In some embodiments, the converter 110 may be capable of bi-directional conversion, such that it may receive data formatted in a protocol compatible with the load and convert the data to an industry-standard communication protocol. Such embodiments may generally be utilizing a bi-directional industry standard communication protocol, wherein status feedback or other data is expected to be received from the load, to provide a user an indication of any number of operating parameters.

The power unit 108 may comprise any suitable power source for providing power to the loads through each output 102. In many embodiments, the power unit 108 is further required to act as a power source for the power supply itself, whereby the power unit 108 receives power from an external source, directs sufficient power to the components of the power supply 100 for operation, and additionally powers any loads connected thereto. In some embodiments, the external source may be a standard AC wall outlet, battery power, solar power, or combinations thereof. The power unit 108 may then convert the external source of power into a voltage supply sufficient for powering the loads, for example, a direct current power supply.

The user interface 122 may comprise any type of interface for receiving operating parameters from a user. The user interface 122 may be capable of receiving input data and/or commands including, for example, a start address for each output, a number of data slots for each output, and the like. In addition, the user interface 122 may be capable of receiving load-specific commands for controlling the particular operation of a load during use (e.g., color schemes, tilt, positioning, or the like). In many embodiments, the commands may be set using at least one of a Binary Coded Decimal (BCD) switches, Dual In-line Package (DIP) switches, Liquid Crystal Display (LCD) with button keys, and Light-Emitting Diode (LED) with button keys, touch-screen Graphical User Interface (GUI) or the like.

In some embodiments the user interface 122 is positioned on or within a housing of the power supply 100. In many other embodiments, however, the user interface 122 is positioned at a remote location from the power supply, for example, in a control room in a venue. In such embodiments, the user interface 122 may operate with a remote controller (not shown), such that the user interface 122 may transmit the data and/or commands to the power supply 100 using at least one of wired, wireless, and optical interface (e.g., Universal Serial Bus (USB) cable).

In certain embodiments, the user interface 122 may also comprise a memory for storing controls or instructions for operating a plurality of loads. For example, in a theater setting, it may be desirable to have numerous lighting functions occur either simultaneously or on a predetermined schedule. By allowing a programming operation to store instructions in a memory within the user interface or remote controller, a system may be able to operate without additional user input during operation.

In addition, the user interface 122 may optionally act as a diagnostic display for the user. For example, in certain embodiments wherein the loads are capable of provide operation feedback, the display may provide a visual indication of any status, and relay any feedback to the user. In many embodiments, the feedback may comprise any operating parameter, for example, temperature, power level, angle of tilt, interference channels, or the like.

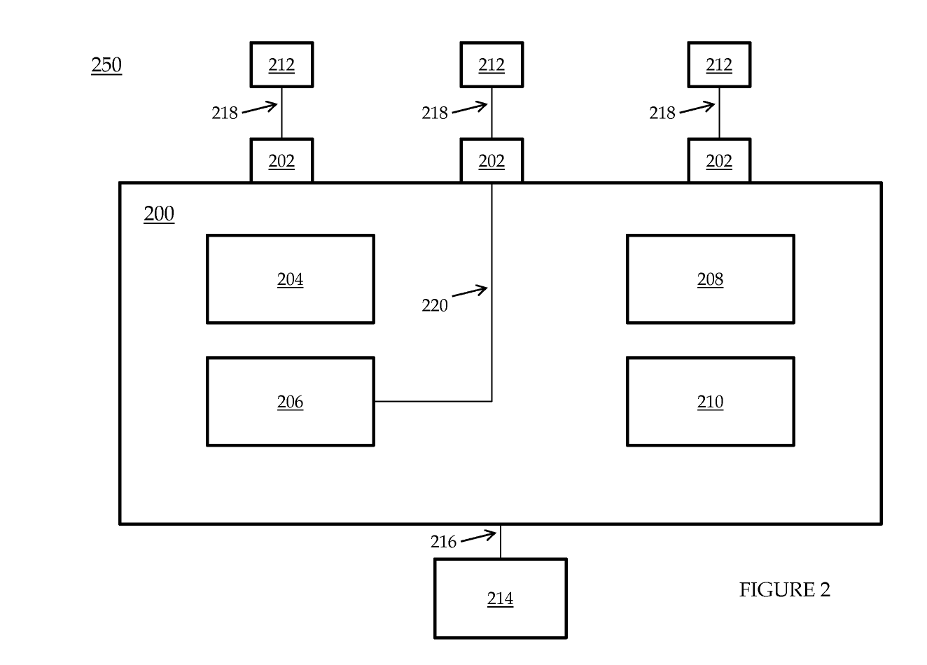

FIG. 2 depicts a schematic diagram of a power supply system in accordance with one embodiment of the present invention. In one embodiment, a power supply system 250 generally comprises a power supply 200, a plurality of loads 212, and optionally a remote controller 214. As discussed above, with respect to FIG. 1, a power supply 200 generally comprises at least a plurality of selectable outputs 202, an input 204, a logic unit 206, a power unit 208, and an optional converter 210.

The remote controller 214 may be configured to remotely transmit control data to the input unit 204 for controlling the loads 212. In many embodiments, the remote controller 214 transmits data and/or commands to the input 204 of the power supply 200 using an industry-standard communication protocol. The transmission of data or commands may take place through at least one of wired, wireless, or optical interface.

In certain embodiments, the remote controller 214 may comprise a user interface, such as user interface 122 described above. In such an embodiment, the remote controller 214 may act as a system monitoring and control device, wherein a user may have full access to and complete knowledge of all loads operating within a system from a single remote controller 214.

The loads 212 may comprise any entertainment fixture, including entertainment lighting and effect devices, for example, stationary and moving luminaries, dimmers, stepper motors, fog/smoke generators, and the like. The loads 212 are generally in communication with the power supply 212 through one of the outputs 202, through a connection means 218.

The connection means 218 may comprise any means suitable for embodiments of the present invention, capable of transmitting power and data, from the power supply 200 to the load 212. In some embodiments, the connection means 218 comprises at least one of a wired or wireless interface between the power supply 200 and the load 212. In one embodiment, exemplary wired interfaces may comprise the use of a digital, analog or optical cable for transmitting data and power. In another embodiment, exemplary wireless interfaces may comprise any wireless communication protocol for transmitting data, and may comprise any wireless power technology, including induction, electrodynamic induction, microwave and laser technology, or the like. In yet another embodiment, combinations of wired and wireless interfaces may be utilized as a connection means 218.

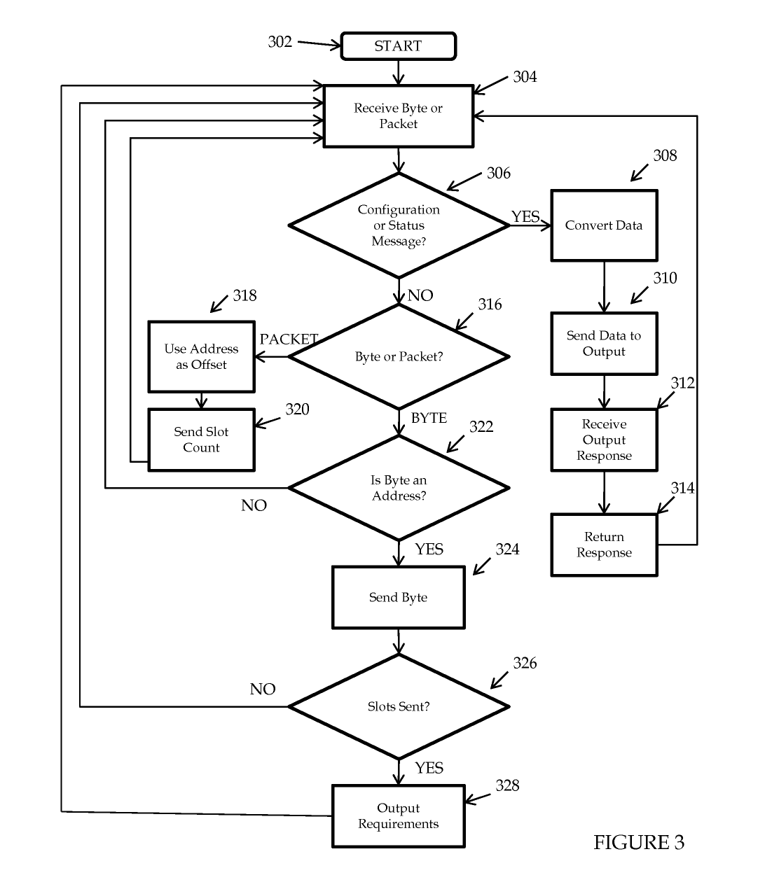

FIG. 3 depicts a flowchart illustrating an exemplary method of processing input data within a power supply in accordance with one embodiment of the present invention. In one exemplary embodiment, the method 300 for operating a plurality of controllable loads starts at step 302. At step 304, a power supply receives data from a remote controller having a user interface therein. At step 306, the logic unit determines whether the data message is a configuration or status message or other type of message.

If the data received is a configuration or status message, at step 308, the data is converted to a format more suitable for instructing the loads. At step 310, the data is sent to the appropriate output, which is identified by certain bit parameters within the data (e.g., identifying an address). Once the data is received by the output, the output may send an output response regarding the data at step 312. The output response may confirm no errors were received, may comprise status information regarding the load or the data, or the like. At step 314, a return response is then transmitted back to the logic unit, and the method 300 returns to step 304.

Returning to step 306, if the data received is not configuration or status message, at step 316, the data is analyzed and determined to be either a byte or a packet. If data received is a packet, at step 318, the address assigned to the port is used as an offset into the data packet. At step 320, the slot count assigned to the port is used to determine how many consecutive slot bytes to send out the port. The method thereafter returns to step 304.

If the data received is a byte, at step 322 the byte's sequence of reception is checked against the assigned address of the port. If the byte sequence does not match the address, the method 300 returns to step 304 to wait additional data. If the byte sequence matches the address assigned, at step 324, the byte is sent to the output port. At step 326, the byte is further evaluated to determine whether the slot count assigned to the port is satisfied. If not, the method 300 returns to step 304 to await addition data. If the slots have been sent, at step 328, the output requirements are evaluated and information is sent to the logic unit for processing. In any event, after step 328, the method 300 returns to step 304.

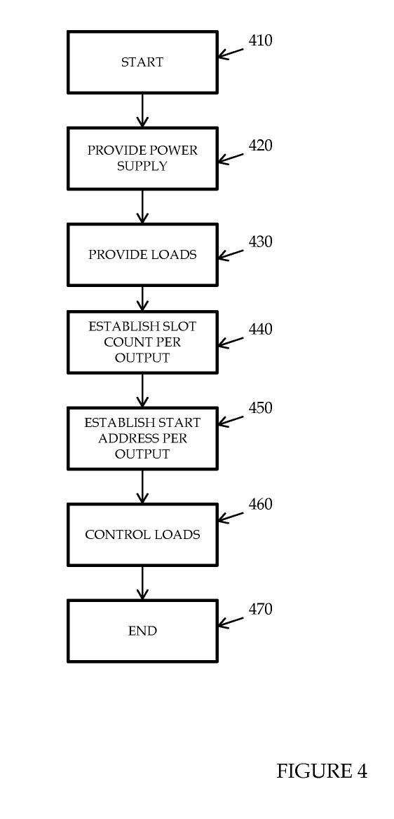

FIG. 4 depicts a flowchart illustrating a method of operating a power supply in accordance with one embodiment of the present invention. The method 400 begins at step 410. At step 420, a power supply is provided. In accordance with embodiment of the present invention, a power supply generally comprises a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output in terms of voltage type (e.g., AC or DC power, etc.) and current, and a converter configured to receive the data formatted in the industry-standard communication protocol and convert the data to a protocol compatible with a load.

At step 430, a plurality of loads are also provided, and each load is placed in communication with an output of the power supply. The loads may comprise any entertainment or architectural fixture, including entertainment or architectural lighting and effect devices, for example, stationary and moving luminaries, dimmers, stepper motors, fog/smoke generators, and the like

At step 440, using a user interface, a user may establishing a number of slots for each output of the power supply, and may constructively associate a number of loads therewith. For example, in one embodiment, a first output may be set to comprise 5 slots for loads, and a second output may be set to comprise 3 slots for loads. At step 450, using the user interface, a user may assign a start address for each output of the power supply. The start address may comprise a DMX address, or the like, for identifying where specific data and commands should be directed by the logic unit.

At step 460, the user provides a set of commands, via the user interface, to control at least one or more of the loads. The method 400 ends at step 470. It should be appreciated, however, the method 400 may be repeated as many times as desired, particularly steps 440-460. The steps may be executed substantially simultaneously, to the extent that a user may provide such commands via the user interface at any time during operation.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A power supply, comprising:
a plurality of outputs, each output configured for an assignable start address and a variable number of slots;
an input for receiving data formatted in an industry-standard communication protocol;
a logic unit configured to assign the start address and the number of slots for each output, the logic unit further configured to selectively distribute received data to each output;
a power unit configured to provide power through each output; and
a converter configured to receive the data formatted in the industry-standard communication protocol and convert the data to a protocol compatible with a load.

2. The power supply of claim 1, wherein each of the plurality of outputs comprise an industry-standard connector.

3. The power supply of claim 1, wherein the load comprises at least one of a stationary or moving luminary, a dimmer, a stepper motor, or a fog or smoke generator.

4. The power supply of claim 3, wherein the stationary or moving luminary is a light-emitting diode (LED).

5. The power supply of claim 1, wherein the input comprises an industry-standard connector.

6. The power supply of claim 1, wherein the industry-standard communication protocol comprises at least one of DMX512, Remote Device Management (RDM), Advanced Control Network (ACN), ArtNet, American National Standards Institute (ANSI), W-DMX, Bluetooth, WiMax, Wi-Fi, Ultra Wideband (UWB), Wireless Application Protocol (WAP), Universal Mobile Telecommunications System (UMTS), Evolution-Data Optimized (EV-DO), High Speed Packet Access (HSPA), Code Division Multiple Access 2000 (CDMA2000), General Packet Radio Service (GPRS), Global System for Mobile Communications (GSM), Enhanced Data Rates for GSM Evolution (EDGE), Wibree, ZigBee, Z-Wave, Wireless Universal Serial Bus (WUSB), EnOcean, ONE-NET, Long Term Evolution (LTE), or Lumen data.

7. The power supply of claim 1, wherein the start address is a DMX512 address.

8. The power supply of claim 1, wherein the power unit is configured to provide at least one of constant Direct Current (DC) voltage or Alternating Current (AC voltage), required to power the load.

9. The power supply of claim 8, wherein the power unit obtains power from at least one of a battery, an AC power source, solar panels, or combinations thereof.

10. The power supply of claim 1, wherein the converter unit is further configured to receive data formatted in a protocol compatible with the load and convert the data to an industry-standard communication protocol.

11. The power supply of claim 1, further comprising:
a user interface unit for accepting operating parameters from a user and transmitting the parameters to the logic unit.

12. The power supply of claim 11, wherein the user interface unit comprises at least one of Binary Coded Decimal (BCD) switches, Dual In-line Package (DIP) switches, Liquid Crystal Display (LCD) with button keys, and Light-Emitting Diode (LED) with button keys.

13. A power supply system, comprising:
a controller for transmitting control data to a power supply, the control data formatted in an industry-standard communication protocol;
a plurality of loads; and
a power supply, comprising:
a plurality of outputs, each output configured for an assignable start address and a variable number of slots;
an input for receiving control data from the controller;
a logic unit configured to assign the start address and the number of slots for each output, the logic unit further configured to selectively distribute received control data to each output;
a power unit configured to provide power through each output; and
a converter configured to receive the control data formatted in the industry-standard communication protocol and convert the control data to a protocol compatible with at least one of the plurality of loads.

14. The power supply system of claim 13, wherein the industry-standard communication protocol comprises at least one of DMX512, Remote Device Management (RDM), Advanced Control Network (ACN), ArtNet, American National Standards Institute (ANSI), W-DMX, Bluetooth, WiMax, Wi-Fi, Ultra Wideband (UWB), Wireless Application Protocol (WAP), Universal Mobile Telecommunications System (UMTS), Evolution-Data Optimized (EV-DO), High Speed Packet Access (HSPA), Code Division Multiple Access 2000 (CDMA2000), General Packet Radio Service (GPRS), Global System for Mobile Communications (GSM), Enhanced Data Rates for GSM Evolution (EDGE), Wibree, ZigBee, Z-Wave, Wireless Universal Serial Bus (WUSB), EnOcean, ONE-NET, Long Term Evolution (LTE), or Lumen data.

15. The power supply system of claim 13, wherein each of the plurality of loads comprises at least one of a stationary or moving luminary, a dimmer, a stepper motor,

16. The power supply system of claim 13, wherein the converter unit is further configured to receive data formatted in a protocol compatible with the load and convert the data to an industry-standard communication protocol.

17. The power supply system of claim 13, wherein the power unit is configured to provide at least one of constant Direct Current (DC) voltage or Alternating Current (AC voltage), required to power the at least one load.

18. A method for operating a plurality of controllable loads, comprising:
providing a power supply, the power supply comprising:
a plurality of outputs, each output configured for an assignable start address and a variable number of slots;
an input for receiving data formatted in an industry-standard communication protocol;
a logic unit configured to assign the start address and the number of slots for each output, the logic unit further configured to selectively distribute received data to each output;
a power unit configured to provide power through each output; and
a converter configured to receive the data formatted in the industry-standard communication protocol and convert the data to a protocol compatible with a load;
providing a plurality of loads;
establishing a first number of slots for a first output of the plurality of outputs, and associating a number of loads therewith;
establishing a second number of slots for a second output of the plurality of outputs, and associating a number of loads therewith;
assigning a first start address with the first output; and
assigning a second start address with the second output.

19. The method of claim 18, wherein the first number of slots, the second number of slots, the first start address and the second start address are provided by a user interface in communication with the power supply.

20. The method of claim 19, wherein the user interface is positioned remote from the power supply.
